(19) United States
(12) Patent Application Publication
(10) Pub. No.: US 2024/0401750 A1
(43) Pub. Date: Dec. 5, 2024

(54) A SYSTEM FOR PRESSURIZED GAS STORAGE AND/OR TRANSFER

(71) Applicant: NGLTECH SERVICES SDN. BHD., Kuala Lumpur (MY)

(72) Inventors: Chin Kiat SEE, Kuala Lumpur (MY); Nik Ridhwan Daud Bin NIK RAFIK YAACOB DAUD, Kuala Lumpur (MY); Aruljothy SUPPIAH, Kuala Lumpur (MY); Claus Hans Heinrich WOHLERT JENSEN, Kuala Lumpur (MY); Yohgerndrra JOTHY, Kuala Lumpur (MY)

(21) Appl. No.: 18/577,941

(22) PCT Filed: Jan. 20, 2022
(86) PCT No.: PCT/MY2022/050003

§ 371 Date: Jan. 9, 2024

(30) Foreign Application Priority Data
Jan. 21, 2021 (MY) PI2021000347
Mar. 2, 2021 (MY) PI2021001105

(51) Int. Cl. F17C 13/08

(52) U.S. Cl. CPC F17C 13/082; F17C 2201/018; F17C 2201/032; F17C 2201/037; F17C 2205/0142; F17C 2221/033; F17C 2227/048; F17C 2260/046; F17C 2265/068; F17C 2270/0128

(57) ABSTRACT

A gas storage system is provided comprising a surface facility for gas production, and a storage vessel for storing pressurised gas from the surface facility, the gas being transferred from the storage vessel to the surface facility and/or a carrier vessel without substantial change in pressure, wherein the transfer is substantially driven by liquid displacement or elastomeric force.

### FIELD OF INVENTION The invention relates to a system for pressurized gas storage and/or transfer.

### BACKGROUND

A global collaboration is essential to combat climate crisis and the Paris Agreement in 2015 united many countries to work towards a sustainable future. Since then, the global momentum to tackle the climate crisis has been building. According to the World Bank, 40 countries and 20 municipalities have implemented carbon taxes or carbon emissions trading and there are also 88 countries who intend to use a carbon tax to meet their Paris Agreement goals.

In order to meet the stated target, flaring associated gases is soon to be prohibited in offshore locations and their management can be challenging. Gas flaring is a significant source of greenhouse gas emissions (GHG) with large amounts of carbon being emitted to the atmosphere. Furthermore, Malaysia holds significant quantities of stranded gas. This may be gas produced from existing facilities as a by-product of the oil production process or stranded gas fields that are un-economical to develop with presently available technologies.

These gases can be used for onsite energy production, but in most cases the amount of produced gas largely exceeds platform fuel gas requirements. Exporting these gases by a subsea pipeline can be quite costly, particularly as water depth increases. Various means are available for the monetization of associated gas and non-associated gas from stranded fields. These include offshore liquid natural gas (LNG), gas-to-liquid (GTL), conversion of gas to electricity (GTW) and gas-to-electrochemical (GTE). The stated technologies are very expensive and are only suitable for large developments. In addition, in many cases, the system results in further environmental emissions to monetize the flare gas.

One of the most economic methods of monetizing relatively small volumes of gas from stranded fields is the process of conditioning produced gas as Compressed Natural Gas (CNG), which is simple and in-expensive. However the logistics and infrastructure associated with such a system is still relatively complex and expensive, making viability of monetizing the stranded gas economically challenging. For example, to eliminate flaring at a stranded oil producing field, multiple CNG Carriers would be required to shuttle between the producing facility and the shore based delivery point to ensure continuous receipt of associated gas from offshore and its subsequent delivery onshore. This becomes even more challenging if the gas quantities are relatively small and production rates fluctuate. For this reason there are many facilities where associated gas is just flared or reinjected as there is no economically viable means to monetize the gas.

In addition, the system for transporting gas from offshore producer to the onshore receiving facilities entails a significant amount of power, first to compress the gas to CNG storage pressures (typically 200 to 250 bar) and to store into CNG pressure vessels and then secondly, to offload the gas decompression facilities to heat the gas which chills due to expansion cooling and re-compression system to depressurize the CNG vessels-down to about 30 barg is typically required. Depending on the configuration of the supply chain for the gas source (producing facility) to the end user, multiple compression decompression and compression cycles may be required which is highly energy consuming. Another issue associated to this operation is the deep chilling of the gas due to expansion/Joule Thompson (JT) cooling and as a result the system will need to be fabricated of materials suitable for the low temperatures and heating facilities for the gas to protect the downstream system. Yet another issue is that the CNG storage vessels are not completely emptied of the gas as this will entail a significant amount of compression duty to completely empty the CNG vessels. Typically the residual pressure in the CNG vessels will be approximately 20 to 30 barg, which means that the net storage capacity of the storage vessel is reduced. The above similarly applies for H₂ producing, storage and transportation system.

Monetizing flare gas and offshore stranded oil & gas fields using CNG has been looked at intensively for many years but to date few, if any, systems have been implemented for offshore applications. Instead associated gas produced from many facilities continue to be reinjected into disposal wells or in some cased flared. One of the main reasons is due to the above mentioned issues with respect to storage and transfer of CNG which makes the system expensive and thus commercially challenging for wider applications.

In an attempt to make the economics of CNG transfer from offshore to onshore receiving facilities more economically viable, a milk run configuration has been considered, where gas from multiple facilities is compressed and stored at the vicinity of the producing facility, and CNG Carrier(s) make milk runs between one or multiple offshore facilities to collect the CNG, and the shore based receiving facility to offload the CNG. While this system appears to be cost effective as the infrastructure is shared between multiple facilities, it entails significant challenges for technical viability. Foremost among the challenges is the need to transfer CNG from one storage facility to another. For example, as shown in FIGS. 13 & 17, if there are 4 offshore gas producing facilities and each facility produces 15 MMscfd gas and on each facility a temporary storage as CNG is provided adequate for 24 hours storage and a single CNG Carrier does a milk run to offload the content of the respective facility based CNG cargo within 3 hours, the whole CNG cargo in the CNG Carrier (total approximately 60 MMscf CNG load from the 4 offshore facilities) is offloaded at the shore base within approximately 5 hours. To enable quick offloading at the offshore facility, to in turn enable the 24 hrs milk run configuration to be viable, offloading of CNG at each facility will need to be done within 3 hour at an average rate of approximately 120 MMscfd. This will require approximately 10 MW of compression power to offload gas from each of the offshore facilities. In addition, to offload the total CNG cargo collected from the 4 offshore facilities (total 60 MMscf) to the onshore supply base within 5 hours requires an average gas transfer rate of 288 MMscfd and approximately 20 MW of compression power is required. This is apart from the heating duties to prevent deep chilling of the CNG during decompression of the CNG storage vessels during the transfer operation. Notwithstanding the huge power consumption required to enable the milk run strategy, there are also operational challenges associated with start/stop operation of large compression units (or pumping units) and this renders this operating strategy very challenging to implement. A method to overcome this is to increase the storage capacity at each facility and the CNG Carrier storage capacity but this will entail larger facility and CNG Carrier sizes and will increase cost of the overall facilities.

Similarly on the onshore CNG supply chain, unless CNG at the onshore receiving facilities is fed directly into the gas pipeline, the CNG is stored in CNG pressure vessels on the onshore side. From here, the CNG may be loaded into CNG transportation trucks where it may be transported loaded into remote CNG stations. For each transfer operation, unless the CNG vessels are physically lifted at the destination facility, a similar transfer operation with decompression and compression facilities will be required.

U.S. Pat. No. 6,655,155 B2 Dated Dec. 2, 2002 by William M. Bishop gives a method to transfer CNG by using a liquid (glycol) to displace the CNG from the storage vessels. This methodology, although it eliminates the issues associated with chilling of the gas due to expansion/JT effects, still requires significant power to pump up the liquids to the pressures of the CNG tanks to displace the CNG. The energy that was to have been consumed by the compressors to empty the CNG vessels is now consumed by the pumps instead, albeit it will be easier to operate pumps than compressors. However, the benefits of such a system as detailed in in the above mentioned patent are marginal after factoring in the added complexity of having another liquid storage, handling and high head pumping system.

Notwithstanding the above another major contributor to GHG emissions are CO₂ emissions. CO₂ emissions are generated from numerous sources with one of the major contributors being power plants due to burning of fossil fuels which include coal, crude oils and natural gas. In addition to onshore power plants, large offshore oil & gas facilities also generate huge amounts of power using fossil fuels which in turn emit huge amounts of CO₂ to the environment.

Apart from these there are huge amounts of natural gas reserves with high CO₂ content that is separated from the hydrocarbon components in the gas stream. Conventionally, CO₂ separated from natural gas is either vented, which causes environmental damage, or reinjected into a disposal reservoir, which is energy consuming and is costly.

It will be beneficial if the CO₂ separated for natural gases or from flue gas can be utilized to extract economic value, like injection into a reservoir for Enhanced Oil Recovery (EOR). However in most cases, the fields that can utilize CO₂ for EOR purposes are remotely located from the producers of CO₂. To ensure continuous removal of CO₂ produced, either a pipeline is required, which may be expensive, or multiple carrier vessels are required, which again is expensive and not commercially viable in many cases.

There is thus a need to develop a holistic solution to facilitate cost effective transport and temporary storage of natural gas, H₂ or CO₂ gases extracted from the location of the producer to the end-users that are typically remotely located from the producers.

### SUMMARY OF INVENTION

In an aspect of the invention, there is provided a gas transfer and/or storage system comprising:
a surface facility for gas production;
a storage vessel for storing pressurised gas from the surface facility;
the gas being transferred from the storage vessel to the surface facility and/or a gas carrier based pressure vessel without substantial change in pressure;
wherein the transfer is substantially driven by liquid displacement and/or elastomeric force.

In one embodiment the storage vessel comprises an inflatable structure for containing gas, and a base for holding down the inflatable structure when placed underwater;

In one embodiment the inflatable structure includes an opening at the lower end thereof configured to be placed in connection with one or more pipelines from which excess gas is received to inflate the inflatable structure, or to which gas is directed from the inflatable structure to deflate the inflatable structure.

Advantageously excess gas can be stored in an inflatable structure underwater where the pressure ensures that the space required for such a structure is minimised.

In one embodiment the inflatable structure is a balloon or a bladder.

In one embodiment, the inflatable structure is made of a multilayered flexible material. Typically the inflatable structure in configured such that the gas is stored at a constant pressure corresponding to the static head of the surrounding water.

Advantageously the external pressure of the water around the inflatable structure displaces the gas in the inflatable structure when gas is directed therefrom. A pump can be used to transfer gas to a surface facility isobarically so that power for compression is not required.

In an alternative embodiment the inflatable structure is made of an elastomer such that the internal pressure is higher than the external static pressure of the surrounding water.

In one embodiment, the inflatable structure is housed in an enclosure with an opening for seawater displacement.

In one embodiment, the inflatable structure comprises a flexible membrane or bladder housed in a pressure vessel which separates the pressure vessel into two compartments, the lower compartment including an opening for receiving fluid thereby expanding the membrane or bladder upwards, the upper compartment containing motive fluid such that the membrane or bladder can be expanded downwards when the fluid is discharged from the upper compartment.

Typically the compartments are at a pressure of up to 100 barg when both are substantially filled with fluid, and around 50 barg when the lower compartment is substantially empty.

Advantageously the pressure differential at the membrane will be minimal or whatever is required to achieve the desired expansion of the membrane, which is useful for shallow water cases where an inflatable bag may pose challenges with respect to size due the very low static pressure of the surrounding seawater or exposure to severe wave conditions nearby.

In an alternative embodiment, the excess gas is stored under pressure without the need for a rigid thick walled pressure vessel.

In one embodiment, the system may be used as a dewpoint control unit to recover condensates from the gas by capturing accumulated condensed liquids as gas is drawn off from the inflatable structure.

In one embodiment, the system is used as temporary buffer storage of CO₂ that is separated offshore from natural gas.

In one embodiment a leak detection line is provided and routed to the surface facility for detection of fluid leaks from the inflatable structure. Typically the leak detection line is an annulus bleed line and detection of hydrocarbon fluid therein is indicative of a leak.

In one embodiment the fluid is excess gas or liquid from a surface facility. Typically a blowdown of the gas within the storage vessel is initiated if a leak is detected.

In one embodiment the system provides for isobaric gas transfer for loading operation and unloading operation with little or no containment pressure loss. Thus fluid can be transferred between surface facility, storage vessel and/or carrier vessel isobarically.

In one embodiment a gas carrier-based pressure vessel, prefilled with a liquid which is inert to gas, is connected to the storage vessel for pressure equalization when connected to the storage vessel, and the liquid is pumped into the storage vessel to displace the fluid such that it is routed to the carrier vessel, typically with substantially no pressure loss. Typically a pump is required of sufficient power to overcome friction losses and/or static head.

Advantageously the pump absorbed power is less than 5% of a conventional system, typically less than 2%, as compression is not required.

In one embodiment the system is for pressurized gas storage and transfer.

In a further aspect of the invention there is provided a method of storing subsea gas comprising: directing fluid to or from an inflatable structure located underwater via pipelines, the pipelines being connectable to surface facilities and/or gas carrier ships for sending or receiving fluid respectively.

In a further aspect of the invention, there is provided a method of transferring gas comprising the steps of:
i. storing compressed gas from a production facility in a buffer storage pressure vessel at a first flow rate;
ii. connecting a gas carrier-based pressure vessel to the buffer storage pressure vessel, said gas carrier-based pressure vessel being prefilled with a liquid, which is inert to gas, at or around atmospheric pressure;
iii. equalising the pressure between the carrier-based pressure vessel and the buffer storage pressure vessel; and
iv. transferring liquid from the gas carrier-based pressure vessel to the buffer storage pressure vessel;
wherein the liquid transferred from the gas carrier-based pressure vessel to the buffer storage pressure vessel displaces the gas such that it is routed to the gas carrier-based pressure vessel with substantially no pressure loss at a second flow rate which is significantly higher than the first flow rate.

Advantageously this allows the gas to be transferred substantially isobarically from the storage vessel to the gas carrier, which is much faster than a conventional system as no compression is required.

In one embodiment, after the buffer storage vessels are substantially filled with liquid and the gas has been displaced isobarically to the gas carrier based pressure vessels, liquid in the buffer storage vessel is routed to one or more liquid surge tanks on the gas carrier, typically operated at or around atmospheric pressure.

In one embodiment the buffer storage pressure vessel and/or the gas carrier-based pressure vessel are vertical or inclined. Typically the buffer storage pressure vessel and/or the gas carrier-based pressure vessel each have at least one port for liquid, and at least one port for gas, typically at the bottom and the top thereof respectively. In a further embodiment the top and bottom of the pressure vessels are conical in shape.

Advantageously this helps to ensure that the gas does not mix with the liquid in the connections between respective pressure vessels.

In one embodiment the gas in the gas carrier-based pressure vessel is displaced by liquid to transfer the gas to a shore based gas storage vessel with substantially no pressure loss at a third flow rate which is significantly higher than the first flow rate. Typically the third flow rate is higher than the second flow rate.

This isobaric gas transfer is similar to the embodiment where gas is loaded onto the gas carrier, to allow enough time for the gas carrier to shuttle between the offshore facilities and shore base within the time required to fill gas in the offshore buffer storage vessels to the desired pressure.

In one embodiment the gas storage pressure vessels at the shore base are prefilled with liquid prior to connection with the gas carrier-based pressure vessels for isobaric gas transfer from gas carrier to shore base.

In one embodiment, multiple transfers are performed to transfer gas from production facilities to end users through a milk run.

### BRIEF DESCRIPTION OF DRAWINGS

It will be convenient to further describe the present invention with respect to the accompanying drawings that illustrate possible arrangements of the invention. Other arrangements of the invention are possible, and consequently the particularity of the accompanying drawings is not to be understood as superseding the generality of the preceding description of the invention.

FIG. 1 illustrates a schematic view of a subsea gas storage system according to an embodiment of the invention, in an inflated condition and a deflated condition.

FIG. 2 illustrates a schematic view of use of the system in a FPSO based facility.

FIG. 3 illustrates schematic view of use of the system in a FPSO based facility with a shuttle gas carrier.

FIG. 4 illustrates a schematic flowchart of flare gas elimination in the system.

FIG. 5 illustrates a schematic detailed view of the balloon structure connection to the FPSO.

FIG. 6 illustrates a block diagram showing an alternative configuration of the system with a bladder.

FIG. 7 illustrates a schematic view of a storage mode of the system.

FIG. 8 illustrates a schematic view of a gas offloading mode of the system.

FIG. 9 illustrates a flowchart of an embodiment with a single gas carrier in the system.

FIG. 10 illustrates an embodiment with multiple facilities serviced by a gas carrier.

FIG. 11 illustrates an embodiment where the system is used for CO₂ storage removed by flue gas from power plants.

FIG. 12 (a) illustrates membrane/bladder installed as a circular sheet within the pressure vessel; (b) illustrates the membrane expanding upwards to a hemispherical shape and (c) illustrates the membrane expanding downwards to a hemispherical shape.

FIG. 13 illustrates a typical conventional configuration of the supply chain of CNG from offshore source producer to end user and the typical conventional methodology for gas transfer.

FIG. 14 illustrates an embodiment of the invention for isobaric gas transfer from offshore buffer store pressure vessels to CNG Carrier pressure vessels (a) initial conditions of the pressure vessels at the platform based buffer storage and that at the CNG Carrier based pressure vessels; (b) pressure equalization step of the vessels; (c) isobaric gas transfer step to transfer gas from the pressure vessels on the platform to the CNG Carrier pressure vessels; (d) method to return the displacement liquids used for gas transfer to the CNG Carrier.

FIG. 15 illustrates an embodiment of this invention for isobaric gas transfer from Carrier based CNG store pressure vessels to the Shore based CNG pressure vessels.

FIG. 16 illustrates configuration of the supply chain for CNG from offshore source producer to end user using the isobaric gas transfer per this invention.

FIG. 17 illustrates a milk run configuration with the system.

### DETAILED DESCRIPTION

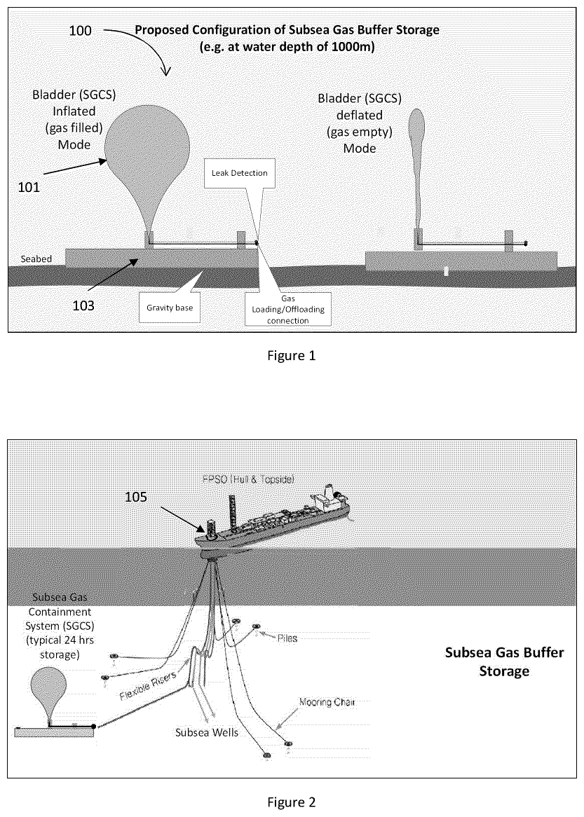

FIG. 1 shows a subsea gas storage system (100) also referred to as a subsea gas containment system (SGCS). The system comprises an inflatable balloon structure (101) with an opening at the base of the balloon structure configured to be placed in connection with pipelines carrying excess gas and a gravity base (103) which holds down the inflatable balloon. The excess gas is stored at a constant pressure corresponding to the static head of the surrounding water, and delivered at relatively constant pressure in an energy efficient manner that avoids decompression of the CNG in the containment system and recompression of the CNG as the containment system is emptied.

In the following description, reference is made to CNG but may be applicable to CO₂, H₂ or any other gases to be stored and transferred at elevated pressures.

The system (100) enables storage of large volumes of gas at a host facility which allows for eliminating and monetizing flare gas and to develop stranded fields. Storage of gas produced in a subsea buffer storage facility is used to mitigate premium space requirements and also to mitigate safety concerns associated with storage of large volumes of gas on a surface host facility.

As the differential pressure between the gas in the system and the surrounding seawater is virtually nil the system will effectively not be a net pressure containing vessel. Although the gas will be stored in the balloon (101) under pressure, it need not be designed for positive pressure containment.

Advantageously the system (100) allows large volumes of gas to be stored under pressure without the need for a thick walled pressure vessel. In addition, as the balloon (101) is inflatable depending on the gas volume contained, the pressure of the gas is in the balloon (101) is always constant i.e. equivalent to the static head of the surrounding water. This is highly beneficial as both the supply and return pressure to and from the balloon (101) remains constant always, irrespective of its level of inflation. This in turn will significantly reduce the complexity and duty of surface facilities compression system. As such the system as described above allows for isobaric (constant pressure) gas transfer for the loading operation and unloading operation of the SGCS without containment pressure loss, apart from losses due to static head and friction.

Further, a gravity base (103) is provided for the balloon (101) to counteract buoyancy forces associated with the difference in gas density stored in the balloon (101) and the seawater. With this configuration, gas from the production facilities can be stored in the balloon (101) for a period of time, which may be hours or days, depending on the gas production rate and the capacity of the balloon (101).

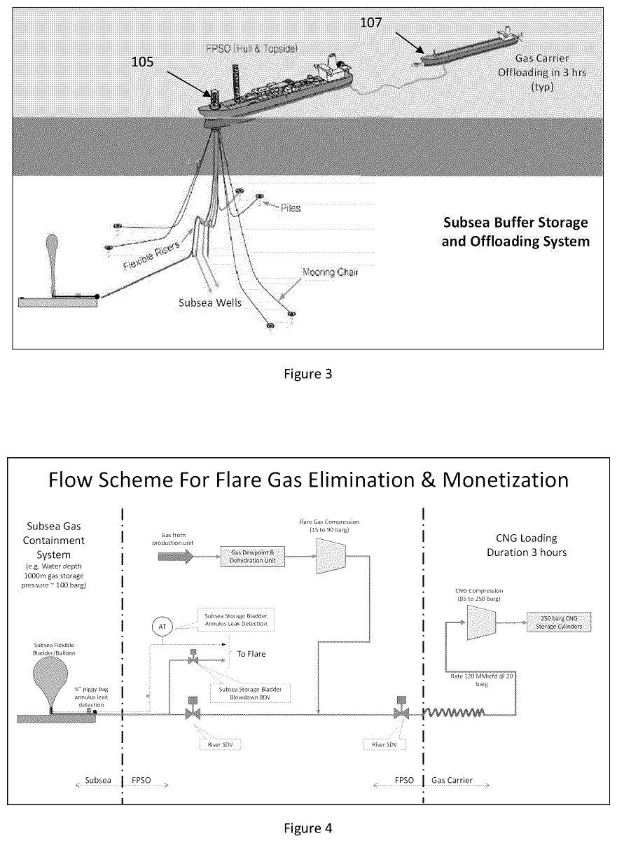

FIG. 2 shows a schematic of a typical FPSO based facility (105) using the system (100) with the balloon (101) is inflated with gas. Periodically and preferably when the balloon (101) is fully inflated with gas, a shuttle Gas Carrier (107) will dock near the surface production facility, in this case the FPSO, to receive at high rates relative to the rate at which the gas was stored in the SGCS along with gas being produced on the production facility as shown in FIG. 3.

FIG. 4 shows a flow schematic of the gas storage system (100) within a gas containment system. Primary protection against leakage is performed at the surface. Leakage due to failure of a primary containment system is detected at surface facilities when hydrocarbon is detected at a leak detection line routed to the surface facilities. The balloon (101) is used as a secondary system of leak protection.

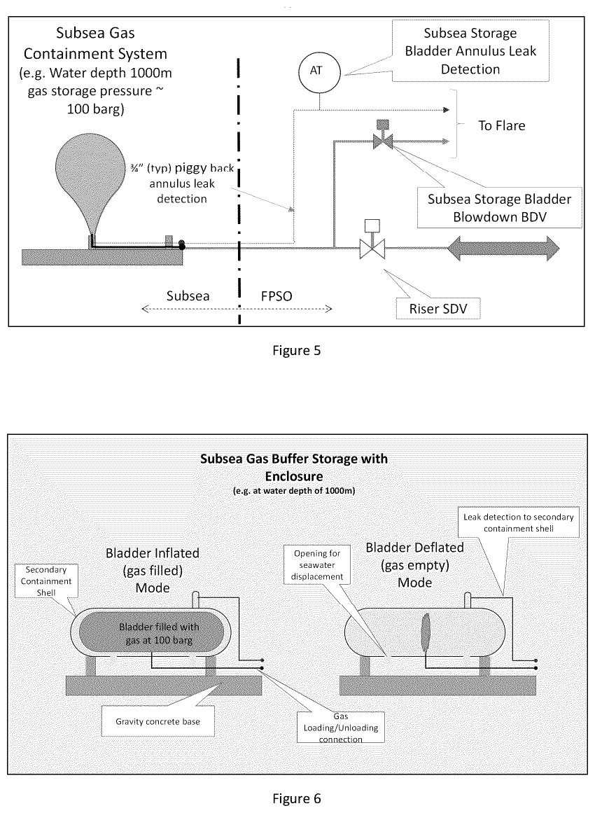

Once a leak is detected at the surface facilities, a blowdown of the gas contained within the balloon (101) may be initiated, either automatically or by manual initiation as seen in FIG. 5. This provides safeguards against gas release to the surface in the event of a leakage or rapture of the balloon (101). The balloon (101) may be made of multilayered flexible material and leakage of the primary layer in contact with the gas may be detected by an annulus bleed line that is routed to the surface facilities. If hydrocarbon gas is detected at the annulus bleed line, it implies there is gas leakage at the primary containment system. An alternative configuration, in lieu of a multilayered bladder or balloon is to house the balloon (101) in an enclosure with opening for seawater displacement as shown in FIG. 6.

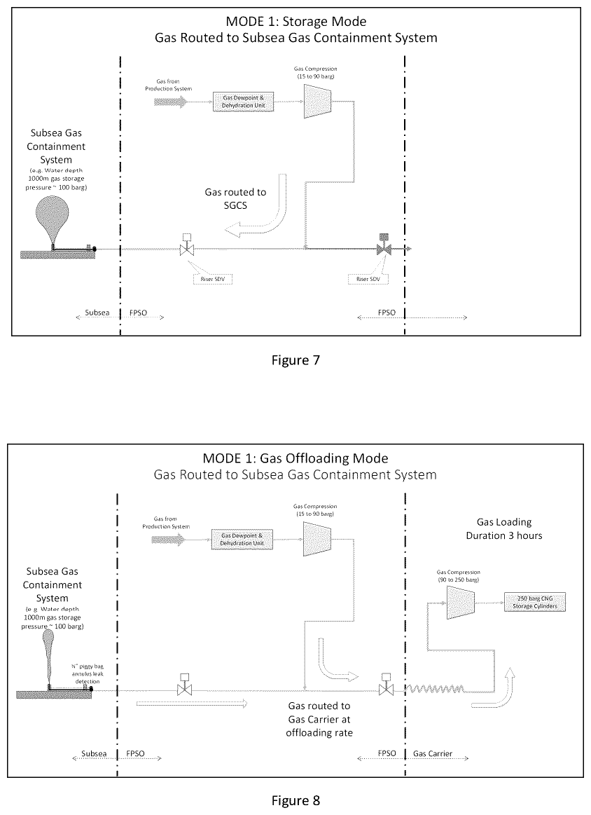

Gas produced at the surface facilities is routed to the balloon or bladder, if required via a compressor, depending on whether the pressure of the gas is adequate for delivery subsea as shown in FIG. 7.

During this period, as the balloon (101) is being deflated with gas being evacuated to a CNG Carrier (107), produced gas from the surface facilities will co-mingle with gas from the balloon (101) flowing to the CNG Carrier. This ensures that there is no flaring even under this operating scenario. It is to be appreciated that gas delivered from the balloon (101) to the surface facility will always be at a constant pressure, irrespective of the level of deflation of the balloon (101). This is highly beneficial as unlike evacuation or depressurization of gas from a pressure vessel where there will be a decay in pressure as gas is removed from the pressure vessel, in the case of the balloon (101), the gas delivery pressure remains constant from the fully inflated condition i.e. gas full to the fully deflated condition i.e. gas empty. This gas offloading mode is illustrated in FIG. 8.

Depending on the requirements of the delivery pressure for the storage of gas at the CNG Carrier (107), a booster compressor may be required either on the surface facilities or at the CNG Carrier. If however the delivery pressure of the gas from the balloon (101) is higher than that required for storage at the CNG Carrier, a pressure letdown valve is provided instead.

As gas is stored in the balloon (101) under pressure and will be at cooler seabed temperatures, the system (100) may be used as a dewpoint control unit to recover condensates from the gas stream routed to the balloon (101). Condensed liquids that accumulate at the base of the balloon (101) will be captured at the surface facilities as gas is drawn off from the (101) during the offloading mode of operation as seen in FIG. 8. In this case, a separator may be provided at the surface facility to separate the liquid from the gas prior to the gas being routed to the CNG Carrier.

In addition, as required, to further condition the gas to export gas requirements, and/or to extract more condensates from the gas stream, the gas may be further dewpointed at the surface facilities, upstream of the booster compression, if provided, prior to being exported. This will enhance valuable condensate recovery and increase revenue.

With the above strategy of providing a cost effective method of storing large gas volumes in the vicinity of the production facility, the CNG Carrier (107) only needs to pick the gas parcels intermittently, without the need for continuous station keeping to collect gas as it is produced.

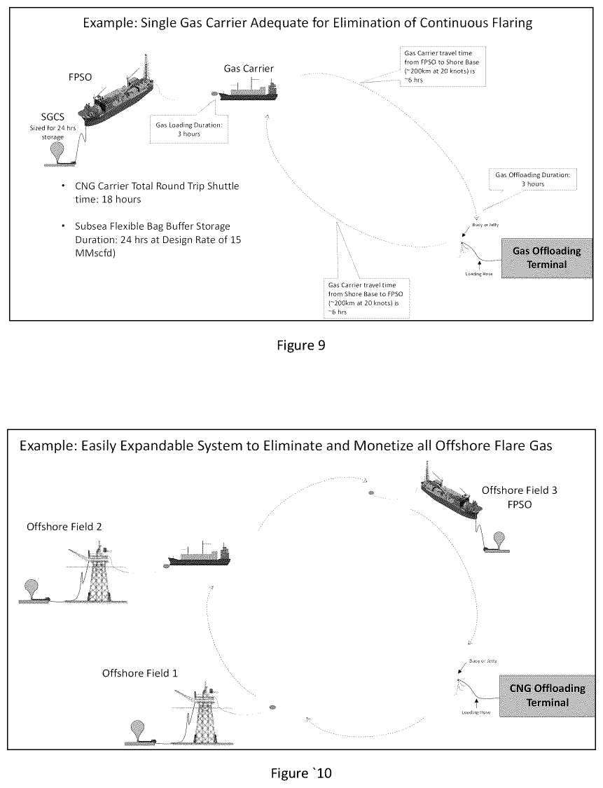

In addition, the system (100) may be expanded to allow a single CNG Carrier to service multiple fields depending on the gas production rates, balloon capacity and the CNG Carrier capacity as seen in FIG. 9. The CNG Carrier will be able to shuttle to multiple facilities, as a milk run configuration, to enable monetization of associated gas that would otherwise be flared as shown in FIG. 10.

In another embodiment of this invention, the system (100) is used as temporary buffer storage of CO₂ that is separated offshore from natural gas. Conventionally CO₂ separated from natural gas is either vented, which causes environmental damage, or reinjected into a disposal reservoir, which is energy consuming and is costly. It will be beneficial if the CO₂ separated can be utilized to extract economic value without causing environmental damage, like injection into a reservoir for Enhanced Oil Recovery (EOR). However in most cases, the fields that can utilize CO₂ for EOR purposes are remotely located from the producer of CO₂. To ensure continuous removal of CO₂ produced, either a pipeline is required, which may be expensive or multiple carrier vessels are required, which again is expensive and not commercially viable in many cases. The subsea gas storage system (100) may be utilized to reduce the logistic requirements to transport the CO₂ produced to the end user destination.

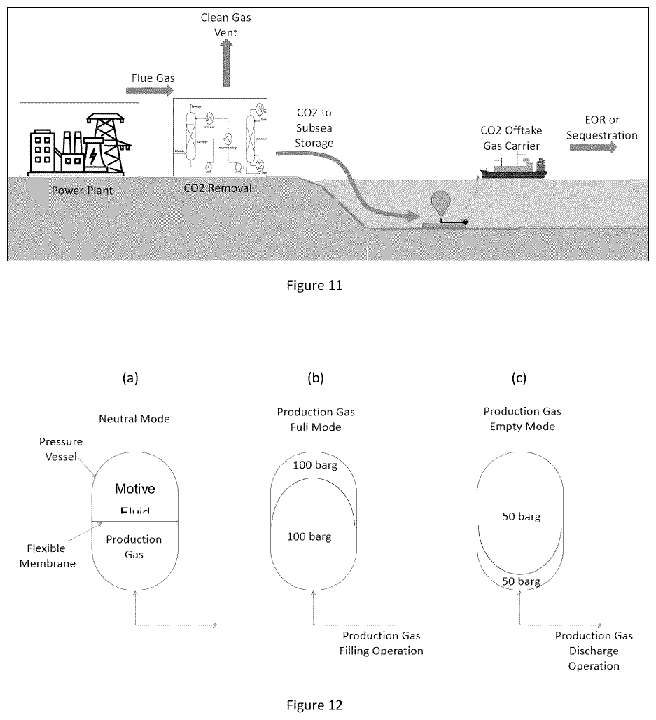

Similarly, for large flue gas emitters like power plants both onshore and offshore, whilst there are technologies to extract environmentally damaging CO₂ from flue gas, the challenge has been for cost effective usage and/or disposal of the removed CO₂ from flue gases. Subsea buffer storage of CO₂, similar to that detailed above would facilitate cost effective transport and utilization of the CO₂ removed from flue gas. FIG. 11 illustrates the schematic of a typical system with subsea buffer storage of CO₂ removed from flue gas generated by power plants.

Whilst the subsea gas storage system (100) is an ideal application for relatively deep water applications, for more shallow water applications, the system becomes fairly limited as the standard volume of gas that can be accommodated in the same volume of bladder or balloon is reduced. For example, 15 million standard cubic feet (MMscf) of gas stored at 1000 m water depth can be accommodated in a bladder volume of approximately 4500 m³. The same gas standard volume to be stored at a water depth of 50 m will require a bladder volume of approximately 90,000 m³! Apart from this, the buoyancy loads will become unmanageable to be practically viable for these volumes.

To overcome this, another embodiment of this invention utilizes a pressure vessel designed using highly elastic and strong material, like an elastomer, that is inflatable and deflatable depending on the amount of gas stored in the vessel. Examples of highly elastic and strong material include NORSelast® which is a polyurethane elastomer. This will enable the vessel to expand under positive differential pressure i.e. internal gas pressure being higher than the external static pressure of the seawater, thus significantly increasing the storage pressure and capacity of the subsea storage system.

It is also noted in some cases, the fluid may be in the liquid phase under the seawater pressure depth and temperature conditions. This is acceptable provided there is sufficient head within the balloon to overcome the static head of the liquid column as the fluid is delivered back to the surface production system.

In a further embodiment of the invention, particularly for shallow water cases where an inflatable bag may pose challenges with respect to size due the very low static pressure of the surrounding seawater and exposure to severe wave conditions in the proximity of the seawater surface, a pressure vessel with a highly flexible bladder can be utilised.

A conventional pressure vessel will completely depressurize the vessel as the gas is emptied, resulting in deep chilling of the gas due to expansion cooling and also result in very low delivery pressure and flowrate of the gas as the vessel is depressurized. This will entail the requirement of additional heating and recompression system at the surface facilities, among others. To mitigate this, a highly flexible membrane/bladder is provided within the vessel with pressurized motive fluid such as inert gas on one side and process gas on the other side of the bladder. This configuration will minimize the pressure variation of the gas during the filling and emptying operation and thus minimize the chilling of gas when the vessel is emptied. In addition the delivery pressure to the surface facilities will be relative high and within a narrow band thus minimizing recompression requirements.

With reference to FIG. 12a, a highly flexible membrane/bladder is installed as a circular sheet within the pressure vessel by internals to keep the membrane in place and leak tight between the two compartments of the vessel. In this example, the upper compartment is filled with motive fluid in the form of an inert gas, and the bottom compartment is used for process gas.

With further reference to FIG. 12b, as process gas is introduced to the vessel from the bottom, the membrane expands upwards to a hemispherical shape.

However, with reference to FIG. 12c, when process gas is discharged from the vessel, the membrane expands downwards to a hemispherical shape to empty the vessel.

The intent of the configuration is to store and deliver gas between pressures of 50 barg to 100 barg. Advantageously the pressure differential at the membrane will be minimal or whatever is required to achieve the desired expansion of the membrane.

It will be appreciated by persons skilled in the art that the present invention may also include further additional modifications made to the system which does not affect the overall functioning of the system.

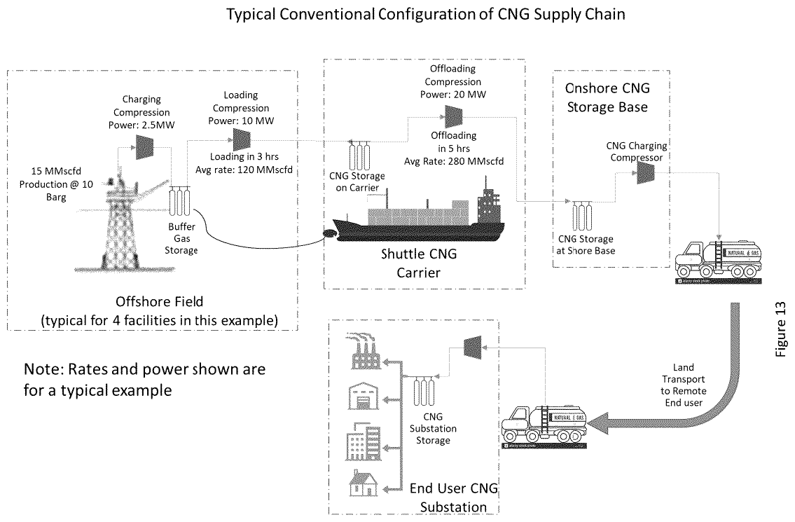

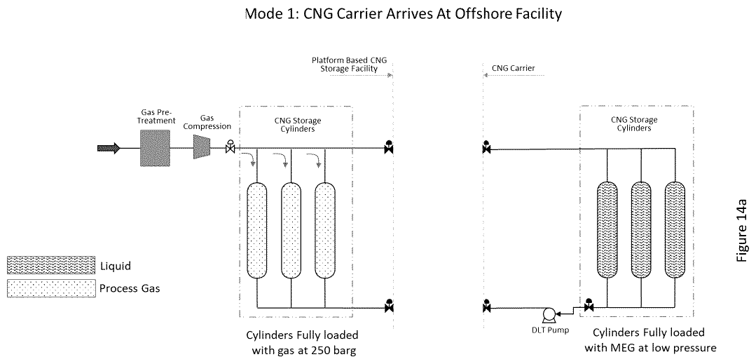

A further embodiment of this invention is the method of gas transfer from the production facility to the end user as CNG. FIG. 13 gives a typical schematic of the conventional supply chain for CNG from the offshore production facility to the end user. As can be seen from this figure, significant power for decompression heating and re-compression is consumed each time CNG is transferred from one storage facility to another.

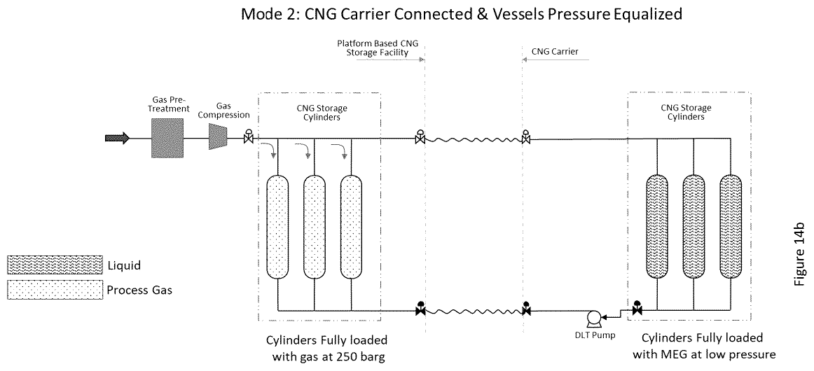

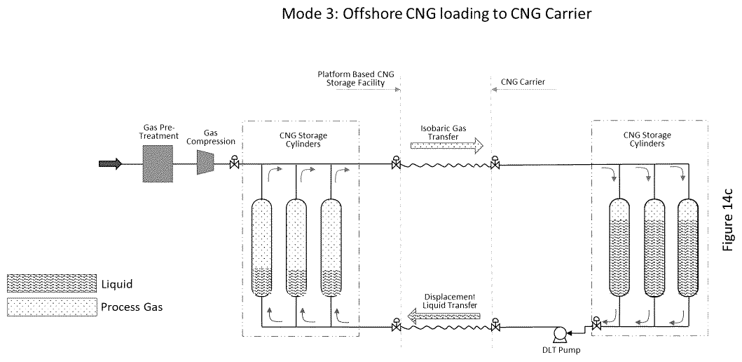

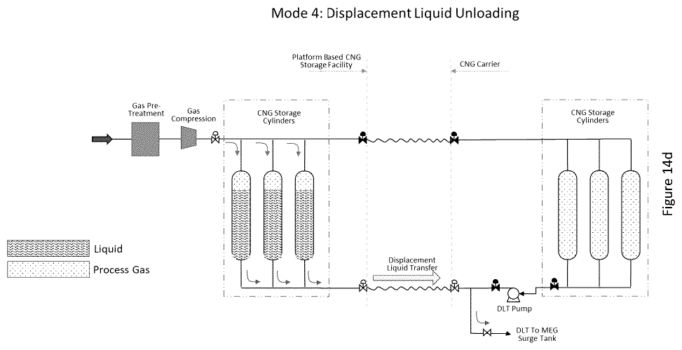

However the invention utilizes constant pressure or isobaric gas transfer to facilitate the gas transfer operation. For the gas transfer from a platform based storage facility, assuming in this case the CNG is stored in pressure vessels, the gas transfer to the shuttle CNG Carrier (107) is depicted in FIGS. 14a through 14d.

If the platform based storage system is a subsea inflatable balloon, as detailed in the previous embodiment of this invention, the gas transfer operation to the CNG Carrier will not be as seen in FIGS. 14a through 14d as the inflatable balloons will already deliver the gas at constant pressure.

As seen in FIG. 14a, the platform based buffer storage pressure vessel gets fully loaded with CNG and is ready to be offloaded to the shuttle CNG Carrier (107). Designated pressure vessels in the CNG Carrier to which the gas from the platform is to be loaded are initially prefilled with an inert liquid which may be glycol like MEG or any other liquid which is inert to the gas. The pressure vessels are configured such that there are at least 2 nozzles, one for gas inlet/outlet preferably at the high point of the vessel and one for liquid inlet/outlet preferably at the low point of the vessel. The vessels are preferably vertical or inclined.

As seen in FIG. 14b, initially the pressure of the gas storage vessels on the platform based system is equalized in pressure with the CNG Carrier based pressure vessels that have been prefilled with glycol by opening a plurality of valvings to connect a gas outlet line. Initially the liquid line at the vessels are in the closed position. Once the pressures are equalized, as seen in FIG. 14c, the plurality of valvings at the liquid line of the vessels are opened, and a liquid transfer pump is started up to transfer liquid from the CNG Carrier based pressure vessels to the platform based pressure vessels. The liquid transferred from the CNG Carrier to the platform based pressure vessels will displace the gas in the pressure vessels which will be routed to the CNG Carrier based pressure vessels at virtually no pressure loss apart from friction loss which is compensated by the liquid transfer pump head. The rate of gas transfer is dependent on the capacity of the liquid transfer pump and the pump head used must sufficiently overcome the friction loss of the pipework connecting the two facilities.

As seen in FIG. 14d, once the platform based vessel is filled with liquid and the designated corresponding CNG Carrier based vessels are emptied of liquid and filled with gas at pressure, the liquid transfer pump is stopped. Liquid level detection at the vessels may be done using differential pressure cells or similar devices to detect liquid level in the vessels.

At this stage the gas outlet/inlet lines of the vessels are closed and the liquid outlet of the vessels at the CNG Carrier is closed. The liquid line from the platform at the CNG Carrier is lined-up to a liquid surge drum operating at low pressure, preferably close to atmospheric pressure. Once this line-up is done, liquids in the platform based vessels will backflow back to the CNG Carrier and into the liquid surge drum. Upon emptying of the vessels of liquid, as detected by the level instruments at the vessels, the liquid outlet line at the vessels is isolated and the gas transfer operation is complete.

For example, if the gas is to be transferred from the platform based system to the CNG Carrier based system at a rate of 120 MMscfd when gas is stored at a pressure of 250 barg and 45° C., the actual volumetric gas flow rate will be 533 m³/h and the liquid transfer rate will be the same. If friction losses due to liquid transfer is 5 bar, the pump head will need to be at least 5 bar. This results in a pump absorbed power of approximately 110 KW. If however, the gas is transferred using the conventional system of decompression and recompression, the compression power requirements is expected to be more than 10 MW. This is assuming that initially the gas will free flow to equalize pressure between the fully gas loaded vessels on the platform and the empty vessels at the CNG Carrier until flow declines to a threshold value. After that, the compressor kicks-in to depressurize the platform based vessels down to approximately 30 barg and pressurize the CNG Carrier based vessels to 250 barg. In addition, there is also heating duty requirements and the associated utilities to provide the heating duties to mitigate the expansion chilling effects as gas is depressurized from the platform based vessels.

As can be seen from the example above, there is significant power savings and reduction in system complexity with this embodiment of the invention. The system also allows for a substantially complete emptying of the platform based vessels. Being significantly less complex to operate, the system also allows fast transfer of gas thus allowing the CNG Carrier to station keep at the platform only for a short duration. This enables the CNG Carrier to collect gas from multiple facilities in a milk run configuration. Liquid inventory carried by the CNG Carrier to be used for the constant pressures i.e. isobaric gas transfer operation can be optimized and minimized by segmenting the pressure vessels on the platform based vessels and the CNG Carrier based vessels with valvings as appropriate. Liquid carry-over into the gas lines are not a concern, unless it is in significant quantities as the system is a closed loop system which will ultimately end-up at the CNG Carrier in any case. Proper design provisions are to be provided to minimize liquid carry-over into the gas line for efficient gas transfer.

Upon completion of the operation, the jumper lines connecting the CNG Carrier with the platform will be disconnected and the CNG Carrier will continue its milk run to the next platform for gas collection. During this transit, liquids from the liquid surge drum will be used to fill-up the empty pressure vessels designated to be filled with gas from the next platform or offshore facility where a similar methodology is used for constant pressure gas transfer.

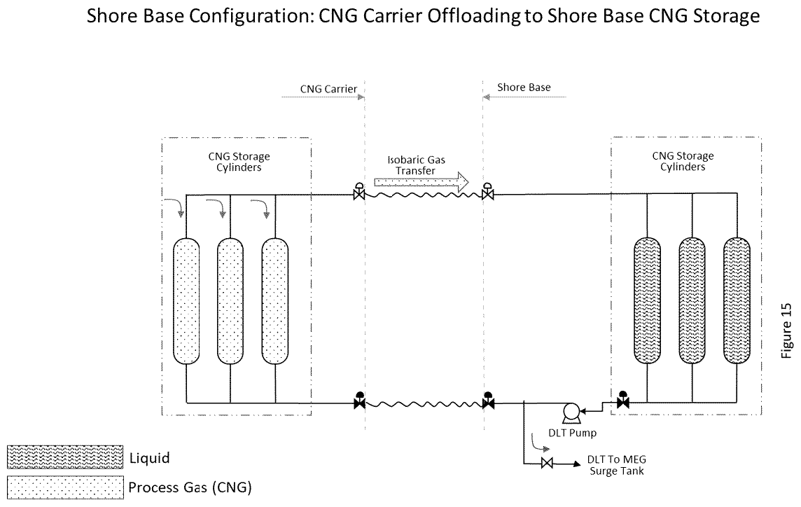

Upon completion of its milk run to collect gas from multiple offshore facilities, the CNG Carrier will finally offload the gas cargo at the gas reception facility which may be an onshore base. In the case when the gas is offload to onshore based gas storage pressure vessels, the gas is transferred in a similar manner at constant pressure to the shore based pressure vessels. In this case, the liquid inventory is managed from the shore based facilities as illustrated in FIG. 15.

Similarly, for the gas transfer for the downstream systems, like transfer of CNG from the shore based storage vessels to CNG transportation trucks, a similar methodology of isobaric gas transfer, as described above may be used.

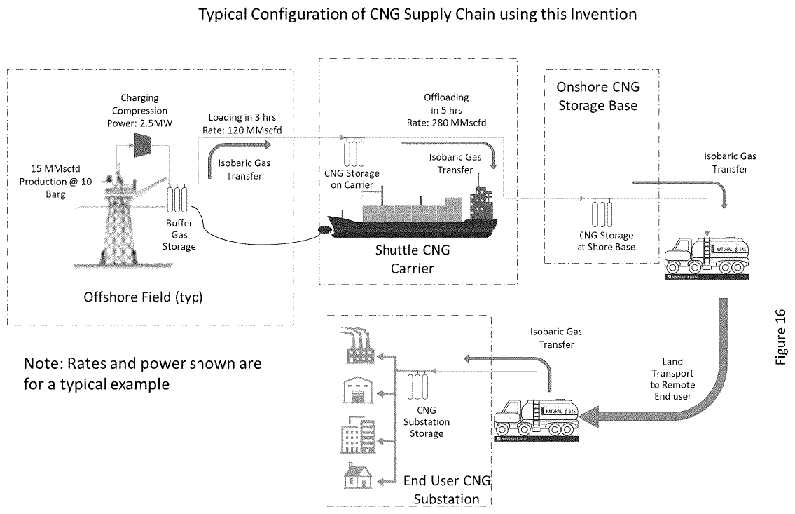

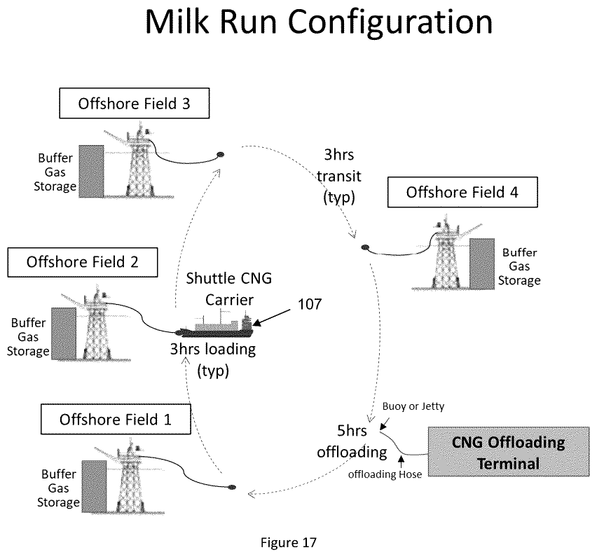

FIG. 16 illustrates configuration of the supply chain for CNG from offshore source producer to end user using the isobaric gas transfer as described in the method above. Compared to a conventional method used for gas transfer, as illustrated in FIG. 13, there are significant savings in energy consumption, reduced system complexity, ease of operation, enables fast gas transfer operation and significant reduction in the cost of the overall system. This invention enables fast and efficient transfer of gas with minimal pressure loss during the transfer operation. This in turn enables the CNG Carrier to perform milk runs to multiple platforms with local buffer gas storage, as illustrated in FIG. 17, enroute to the onshore base.

The system is used as a cost effective means of temporary storage of gas offshore. The system is also used as an energy efficient means of transferring gas from offshore storage system to gas carrier storage and from gas carrier storage system to the onshore base storage system and, as applicable, from the onshore base storage system to the CNG transportation trucks and then to the CNG storage at the end user facility. This avoids high compression or pumping power requirements for the gas transfer operation, avoidance of expansion/JT cooling effects and the associated heating requirements for the gas transfer operation. Further, the system operates as a milk run configuration as illustrated in FIG. 17 wherein the gas transfer operation is undertaken fast, with minimal operational complexity. The system also maximizes utilization of net storage capacity in pressure vessels available for pressurized gas storage, wherein the vessels can be emptied to the maximum level possible whilst being energy efficient.

While the description above is in reference to a CNG system, it is to be appreciated that this invention may be similarly utilized for energy efficient transfer of any pressurized gas, like H₂ or CO₂. In the above, where offshore platform or FPSO is referenced, it is noted that these are only referenced as examples and may also be understood to be any offshore production facility, either fixed or floating.

1. A gas transfer and/or storage system comprising:
a surface facility for gas production;
a storage vessel for storing pressurised gas from the surface facility;
the gas being transferred from the storage vessel to the surface facility and/or a gas carrier based pressure vessel without substantial change in pressure;
wherein the transfer is substantially driven by liquid displacement and/or elastomeric force.

2. A system according to claim 1, wherein the storage vessel comprises
an inflatable structure for containing gas and a base for holding down the inflatable structure when placed underwater.

3. A system according to claim 2, wherein the inflatable structure includes an opening at the lower end thereof configured to be placed in connection with one or more pipelines from which excess gas is received to inflate the inflatable structure, or to which gas is directed from the inflatable structure to deflate the inflatable structure.

4. A system according to claim 2, wherein the inflatable structure is a balloon or a bladder.

5. A system according to claim 2, wherein the inflatable structure is made of multilayered flexible material.

6. A system according to claim 2, wherein the inflatable structure in configured such that the gas is stored at a constant pressure corresponding to the static head of the surrounding water.

7. A system according to claim 2, wherein the inflatable structure is made of an elastomer such that the internal pressure is higher than the external static pressure of the surrounding water.

8. A system according to claim 2, wherein the inflatable structure (101) is housed in an enclosure with an opening for seawater displacement.

9. A system according to claim 1, wherein the storage vessel comprises a flexible membrane or bladder housed in a pressure vessel which separates the pressure vessel into two compartments, the lower compartment including an opening for receiving fluid thereby expanding the membrane or bladder upwards, the upper compartment containing motive fluid such that the membrane or bladder can be expanded downwards when the fluid is discharged from the upper compartment.

10. A system according to claim 9, wherein the compartments are at a pressure of up to 100 barg when both are substantially filled with fluid, and around 50 barg when the lower compartment is substantially empty.

11. A system according to claim 2, wherein the gas is stored under pressure without the need for a rigid thick walled pressure vessel.

12. A system according to claim 1, wherein the system may be used as a dewpoint control unit to recover condensates from the gas by capturing accumulated condensed liquids as gas is directed from the storage vessel.

13. A system according to claim 1, wherein the storage vessel is used as temporary buffer storage of CO₂ that is separated offshore from natural gas.

14. A system according to claim 1, wherein a leak detection line is provided and routed to the surface facility for detection of gas leaks from the storage vessel.

15. A system according to claim 14, wherein the leak detection line is an annulus bleed line and detection of hydrocarbon fluid therein is indicative of a leak.

16. A system according to claim 14, wherein a blowdown of the gas within the storage vessel is initiated if a leak is detected.

17. A system according to claim 1, wherein gas is transferred between the surface facility and the storage vessel and/or the gas carrier based pressure vessel isobarically.

18. A system according to claim 17, wherein the gas carrier based pressure vessel is prefilled with a liquid which is inert to gas for pressure equalization when connected to the storage vessel, and the liquid is pumped into the storage vessel to displace the gas such that it is routed to the gas carrier based pressure vessel using a pump of sufficient power to overcome friction losses and/or static head.

19. A method of storing subsea gas comprising directing fluid to or from an inflatable structure located underwater via pipelines, the pipelines being connectable to surface facilities and/or gas carrier ships for sending or receiving fluid respectively.

20. A method of transferring gas comprising the steps of:
i. storing compressed gas from a production facility in a buffer storage pressure vessel at a first flow rate;
ii. connecting a gas carrier-based pressure vessel to the buffer storage pressure vessel, said gas carrier-based pressure vessel being prefilled with a liquid, which is inert to gas, at or around atmospheric pressure;
iii. equalising the pressure between the carrier-based pressure vessel and the buffer storage pressure vessel; and
iv. transferring liquid from the gas carrier-based pressure vessel to the buffer storage pressure vessel;
wherein the liquid transferred from the gas carrier-based pressure vessel to the buffer storage pressure vessel displaces the gas such that it is routed to the gas carrier-based pressure vessel with substantially no pressure loss at a second flow rate which is significantly higher than the first flow rate.

21. The method according to claim 20, wherein after the buffer storage vessels are substantially filled with liquid and the gas has been displaced isobarically to the gas carrier-based pressure vessels, liquid in the buffer storage vessel is routed to one or more liquid surge tanks on the gas carrier, typically operated at or around atmospheric pressure.

22. The method according to claim 20, wherein the buffer storage pressure vessel and/or the gas carrier-based pressure vessel are vertical or inclined, each having at least one port for liquid, and at least one port for gas, typically at the bottom and the top thereof respectively.

23. The method according to claim 20, wherein the gas in the gas carrier-based pressure vessel is displaced by liquid to transfer the gas to a shore based gas storage vessel with substantially no pressure loss at a third flow rate which is significantly higher than the first flow rate.

24. The method according to claim 23, wherein the gas storage pressure vessels at the shore base are prefilled with liquid prior to connection with the gas carrier-based pressure vessels for isobaric gas transfer from gas carrier to shore base.

25. The method according to claim 23, wherein the third flow rate is higher than the second flow rate.
